(19) United States
(12) Patent Application Publication
(10) Pub. No.: US 2010/0211980 A1
(43) Pub. Date: Aug. 19, 2010

(54) Point of Decision Display System

(76) Inventor: Paul Nair, Atlanta, GA (US)

Correspondence Address: GEORGE R. REARDON, 3356 STATION COURT, LAWRENCVILLE, GA, 30044, US

(21) Appl. No.: 12/371,904

(22) Filed: Feb. 16, 2009

(51) Int. Cl. H04N 5/445; G08B 13/14; G06Q 30/00

(52) U.S. Cl. 725/60; 340/572.1; 705/14.41; 705/14.65

(57) ABSTRACT

The technology described herein provides a point of decision display system and method that delivers an interactive advertisement to a consumer when the consumer is in the process of making a decision. The system includes: a display system controller, a video display device to display an interactive advertisement to a consumer when the consumer is in a process of making a decision, an audio output device to provide audio for the interactive advertisement to the consumer, a sensor processing unit to trigger the display system controller to display the interactive advertisement to the consumer, a presence sensor to sense the consumer in the process of making the decision, and a content delivery server to provide content through the display system controller and video display device to the consumer.

### FIELD OF THE INVENTION

The technology described herein relates generally to systems and associated methods for providing targeted electronic advertising based upon physical proximity of potential consumers to a point of decision display system. More specifically, this technology relates to a point of decision display system that delivers an interactive advertisement to a consumer when the consumer is in the process of making a decision.

### BACKGROUND OF THE INVENTION

Video advertising can be useful in reaching and influencing potential consumers. In many circumstances, however, video advertising is viewed by a consumer at point in time other than that of an actual consumer decision and/or potential purchase.

Related patents known in the art include the following: U.S. Pat. No. 67,451,892, issued to Walker et al. on Nov. 18, 2008, discloses a vending machine system and method for encouraging the purchase of profitable items. U.S. Published Patent application No. 2002/0116265 filed by Hernandez and published on Aug. 22, 2002, discloses a method and apparatus for in-store media advertising. U.S. Published Patent application No. 2007/0007337 filed by Clark et al. and published on Jan. 11, 2007, discloses providing direct content to anonymous customers.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a point of decision display system and method that delivers an interactive advertisement to a consumer when the consumer is in the process of making a decision.

In one exemplary embodiment, the technology described herein provides a point of decision display system. The system includes: a display system controller; a video display device, operably coupled to the display system controller and configured to display an interactive advertisement to a consumer when the consumer is in a process of making a decision; an audio output device, operably coupled to the display system controller and configured to provide audio for the interactive advertisement to the consumer; a sensor processing unit, operably coupled to the display system controller and configured to trigger the display system controller to display the interactive advertisement to the consumer; a presence sensor, operably coupled to the sensor processing unit and configured to sense the consumer in the process of making the decision; and a content delivery server, operably coupled to the display system controller and configured to provide content through the display system controller and video display device to the consumer.

The system can also include a performance monitoring system, operably coupled to the display system controller and configured to monitor performance of the point of decision display system and to gather a plurality of statistical data.

The system can also include a video sensor, operably coupled to the display system controller and configured to gather a plurality of video data about the consumer in a process of making a decision.

The system can also include a radio-frequency identification (RFID) system, operably coupled to the display system controller and having an RFID tag reader, and wherein a plurality of RFID tags are utilized on a plurality of products accessible by the consumer.

The presence sensor can be one or more of a contact sensor, a motion sensor, an infrared sensor. The presence sensor can be a wireless sensor operably and wirelessly connected to the sensor processing unit.

The content delivery server can be a remote content delivery server operably coupled to the display system controller over a communications network and configured to provide content to the display system controller over the communications network.

The display system controller can further include a processor, a video controller, and a sound controller.

The display system controller can be further configured to display a plurality of general audience advertisements until a trigger event is sensed by the presence sensor and a targeted interactive advertisement is displayed.

In another exemplary embodiment, the technology described herein provides a method for point of decision advertising. The method includes: utilizing a point of decision display system; displaying a targeted interactive advertisement, through a video display device operably coupled to a display system controller, to a consumer when the consumer is in a process of making a decision; providing an audio feed of the targeted interactive advertisement to the consumer, utilizing an audio output device operably coupled to the display system controller; and triggering the targeted interactive advertisement to be displayed to the consumer, utilizing a presence sensor operably coupled to a sensor processing unit, the sensor processing unit operably coupled to the display system controller and configured to trigger the display system controller to display the interactive advertisement to the consumer.

The method can also include providing the targeted interactive advertisement to the consumer, wherein the targeted interactive advertisement comprises a content derived from a content delivery server operably coupled to the display system controller and configured to provide content through the display system controller and video display device to the consumer.

The method can also include monitoring performance of the advertising utilizing a performance monitoring system operably coupled to the display system controller and configured to monitor performance of the point of decision display system and to gather a plurality of statistical data.

The method can also include gathering a plurality of video data utilizing a video sensor operably coupled to the display system controller and configured to gather a plurality of video data about the consumer in a process of making a decision.

The method can also include displaying a plurality of general audience advertisements until a trigger event is sensed by the presence sensor and the targeted interactive advertisement is displayed to the consumer.

The method can also include influencing the customer at a point of decision with the targeted interactive advertisement.

The method can also include remotely accessing, loading, and maintaining, from the content delivery server, the display system controller, wherein the content delivery server is a remote content delivery server operably coupled to the display system controller over a communications network and configured to provide content to the display system controller over the communications network.

The method can also include utilizing a radio-frequency identification (RFID) system operably coupled to the display system controller and having an RFID tag reader and utilizing a plurality of RFID tags on a plurality of products accessible by the consumer.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a schematic diagram depicting a point of decision display system, according to an embodiment of the technology;

FIG. 2 is a schematic diagram depicting a point of decision display system, according to an embodiment of the technology;

FIG. 3 is a schematic diagram of the general components of a computer, according to an embodiment of the technology described herein;

FIG. 4 is a flowchart diagrams depicting a method for conducting a point of decision display, according to an embodiment of the technology described herein;

FIG. 5 is a flowchart diagrams depicting additional method steps for conducting a point of decision display, according to an embodiment of the technology described herein; and

FIG. 6 is a schematic diagram depicting a point of decision display system, according to an embodiment of the technology.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a point of decision display system and method that delivers an interactive advertisement to a consumer when the consumer is in the process of making a decision.

Throughout the disclosure, reference is made to a consumer making a decision. The decision can be, for example, the purchasing decision a consumer makes in a retail establishment regarding what product to buy. Additionally, the decision being made can be a decision in an institution of learning (e.g. schools, universities, colleges, libraries, etc.), such as a decision on what book to check out or what course to enroll in, or which event to sign up for. Similarly, consumer decisions addressed by the technology described herein can include decisions on whether to join a club, whether to run for student council, whether to register for membership or upgrade a membership, and so forth. As will be apparent to those of ordinary skill in the art, the technology described herein can be applied in many diverse venues in which a consumer is making some form of a decision and wherein that decision can be influenced and/or guided by video advertising.

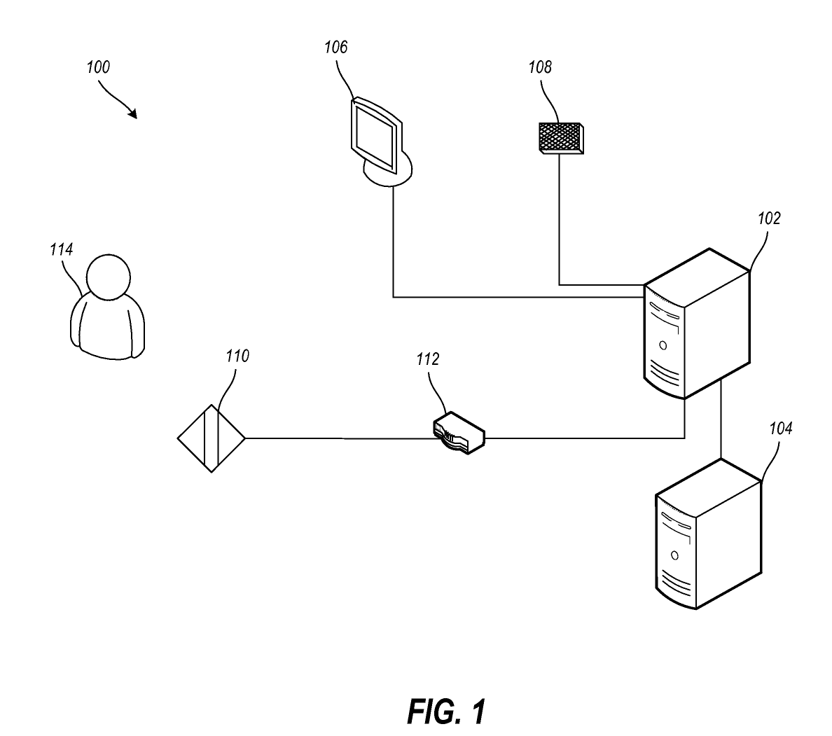

Referring now to FIG. 1, a point of decision display system 100 is shown. The point of decision display system 100 includes a display system controller 102. The display system controller 102 includes a processor 302 and video and sound controllers 304.

The display system controller 102 is configured to control one or more video display devices 106. The video display device 106 can be a screen, monitor, projection system, or the like. Each video display device 106 is operably coupled to the display system controller 102 and configured to display an interactive advertisement to a consumer 114 when the consumer 114 is in a process of making a decision.

The display system controller 102 also is configured to control simultaneously with the video display devices 106 one or more audio output devices 108. Each audio output devices 108 is operably coupled to the display system controller 102 and configured to provide audio of an interactive advertisement to a consumer 114 when the consumer 114 is in a process of making a decision.

The point of decision display system 100 includes a sensor processing unit 112. The sensor processing unit 112 is operably coupled to the display system controller 102 and configured to trigger the display system controller 102 to display the interactive advertisement to the consumer 114. The point of decision display system 100 includes at least one presence sensor 110 operably coupled to the sensor processing unit 112 and configured to sense or detect the consumer 114 in the process of making the decision. The presence sensor 110 can be a contact sensor 110 such as sensor having magnetic contacts. The presence sensor 110 can be a motion sensor to detect the motion of the customer 114. The presence sensor 110 can be an infrared sensor 110c to utilize the invisible light spectrum to detect the customer 114. Additionally, any presence sensor 110 can be a wireless device to wirelessly communicate with the sensor processing unit 112.

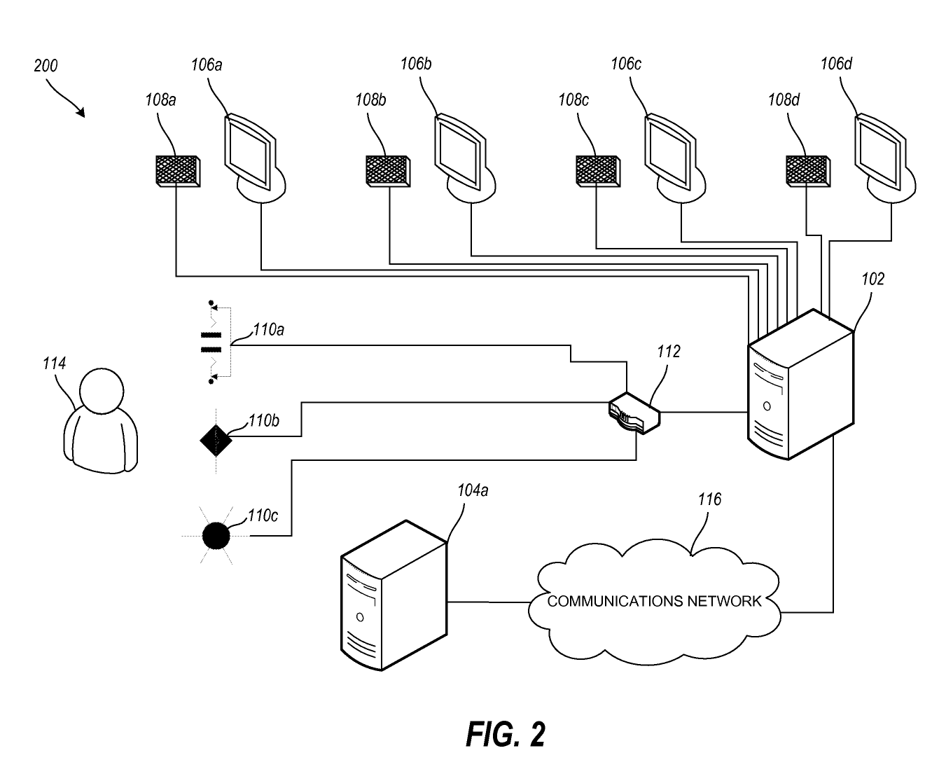

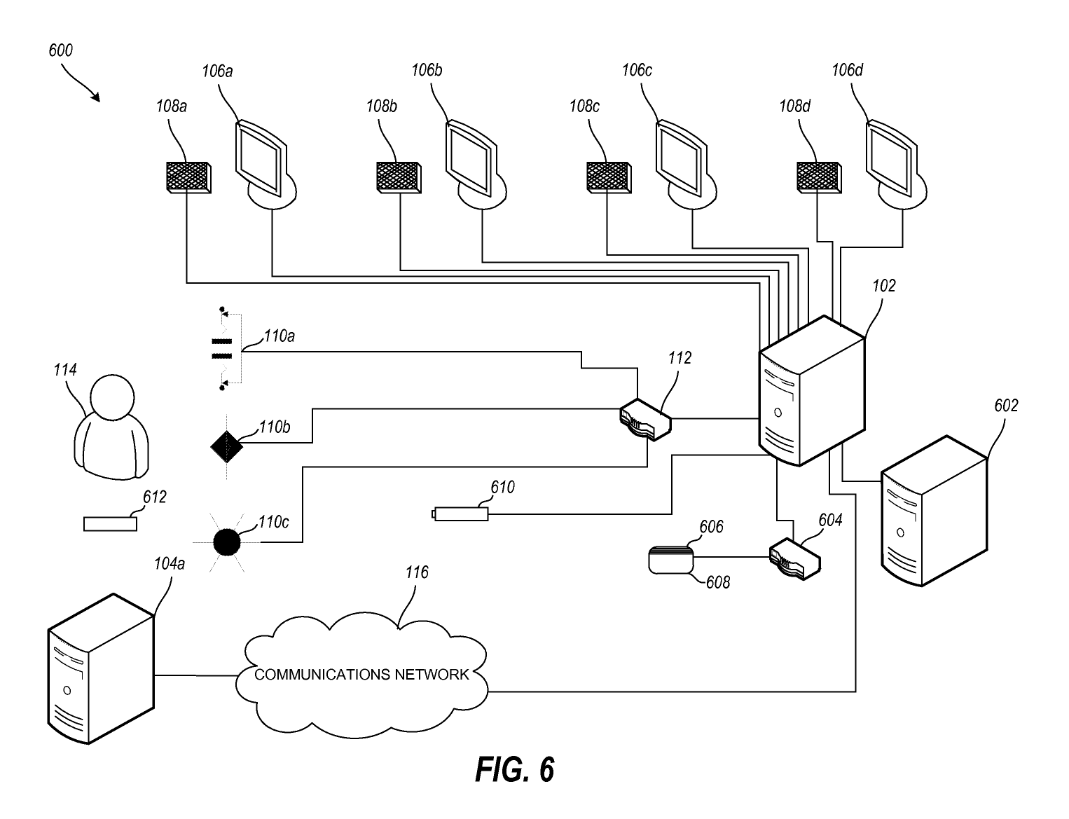

The point of decision display system 100 includes a content delivery server 104. The content delivery server 104 is operably coupled to the display system controller 102 and configured to provide content through the display system controller 102 and video display device to the consumer 114. In at least one embodiment, the content delivery server 104 is a remote content delivery server 104a operably coupled to the display system controller 102 over a communications network 116 and configured to provide content to the display system controller 102 over the communications network 116. The communications network 116 can be the Internet. The content delivery server 104 is depicted as a remote content delivery server 104a in FIGS. 2 and 6. Diagrams 200 and 600 illustrate alternative configurations of the point of decision display system 100.

In FIG. 6, another embodiment of the point of decision display system 100 is shown. In addition to the system components depicted in FIGS. 1 and 2, the point of decision display system 100 of FIG. 6 includes a performance monitoring server 602, operably coupled to the display system controller 102 and configured to monitor performance of the point of decision display system 100 and to gather a plurality of statistical data.

Additionally, the point of decision display system 100 of FIG. 6 includes a video sensor 610, operably coupled to the display system controller 102 and configured to gather a plurality of video data about the consumer 114 in a process of making a decision.

Additionally, the point of decision display system 100 depicted in FIG. 6 includes a radio-frequency identification (RFID) system operably coupled to the display system controller 102 and having an RFID tag reader 604. RFID tag 606 is shown on consumer product 608. A multiplicity of RFID tags are utilized on a plurality of products accessible by the consumer.

Additionally, the point of decision display system 100 depicted in FIG. 6 includes a wireless sensor 612. The wireless sensor 612 is wirelessly coupled to the sensor processing unit 102 and is configured to sense the consumer 114 in the process of making the decision.

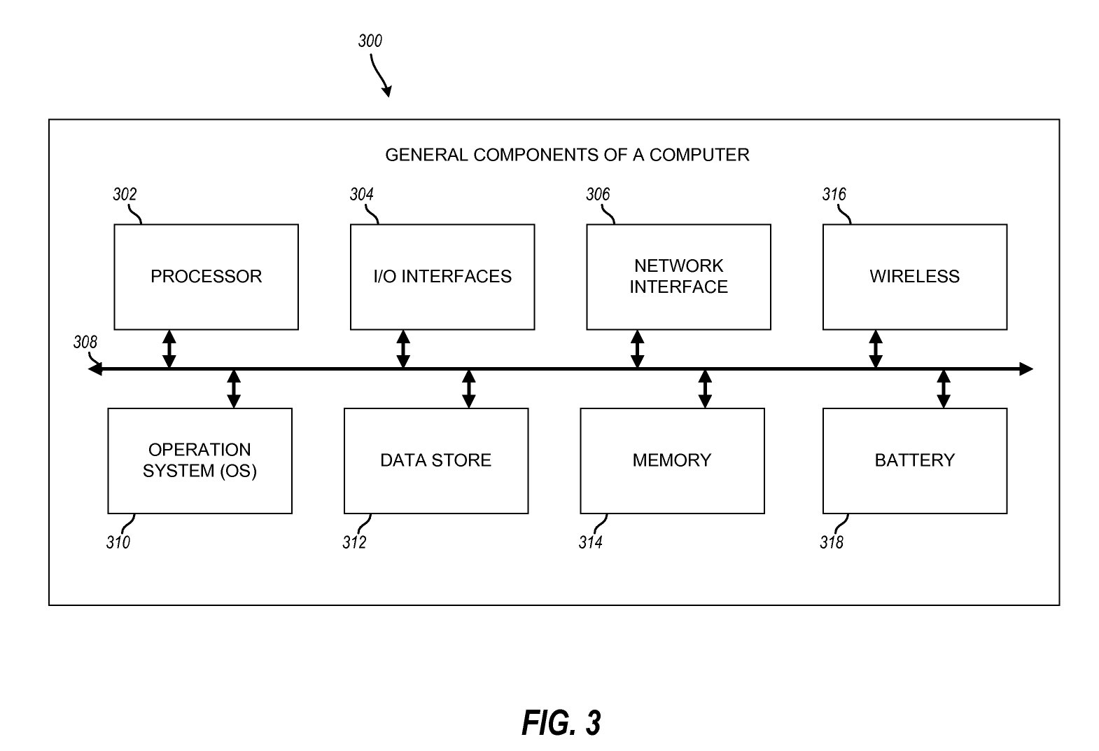

Referring now to FIG. 3, a block diagram 300 illustrating the general components of a computer is shown. The computer can be a digital computer that, in terms of hardware architecture, generally includes a processor 302, input/output (I/O) interfaces 304, network interfaces 306, an operating system (O/S) 310, a data store 312, and a memory 314. Additionally, the computer can include battery 318 in portable configurations and wireless connectivity 316. The components (302, 304, 306, 310, 312, 314, 316, and 318) are communicatively coupled via a local interface 308. The local interface 308 can be, for example but not limited to, one or more buses or other wired or wireless connections, as is known in the art. The local interface 308 can have additional elements, which are omitted for simplicity, such as controllers, buffers (caches), drivers, among many others, to enable communications. Further, the local interface 308 can include address, control, and/or data connections to enable appropriate communications among the aforementioned components. The general operation of a computer comprising these elements is well known in the art.

The processor 302 is a hardware device for executing software instructions. The processor 302 can be any custom made or commercially available processor, a central processing unit (CPU), an auxiliary processor among several processors associated with the computer, a semiconductor-based microprocessor (in the form of a microchip or chip set), or generally any device for executing software instructions. When the computer is in operation, the processor 302 is configured to execute software stored within the memory 314, to communicate data to and from the memory 314, and to generally control operations of the computer pursuant to the software instructions.

The I/O interfaces 304 can be used to receive user input from and/or for providing system output to one or more devices or components. User input can be provided via, for example, a keyboard and/or a mouse. System output can be provided via a display device and a printer (not shown). I/O interfaces 304 can include, for example but not limited to, a serial port, a parallel port, a small computer system interface (SCSI), an infrared (IR) interface, a radio frequency (RF) interface, and/or a universal serial bus (USB) interface.

The network interfaces 306 can be used to enable the computer to communicate on a network. For example, the computer can utilize the network interfaces 306 to communicate via the internet to other computers or servers for software updates, technical support, on so forth. The network interfaces 306 can include, for example, an Ethernet card (e.g., 10 BaseT, Fast Ethernet, Gigabit Ethernet, etc.) or a wireless local area network (WLAN) card (e.g., 802.11a/b/g, etc.). The network interfaces 306 can include address, control, and/or data connections to enable appropriate communications on the network.

A data store 312 can be used to store data, such as information regarding positions entered in a requisition. The data store 312 can include any of volatile memory elements (e.g., random access memory (RAM, such as DRAM, SRAM, SDRAM, and the like)), nonvolatile memory elements (e.g., ROM, hard drive, tape, CDROM, etc.), and combinations thereof. Moreover, the data store 312 can incorporate electronic, magnetic, optical, and/or other types of storage media. In one example, the data store 312 can be located internal to the computer such as, for example, an internal hard drive connected to the local interface 308 in the computer. Additionally in another embodiment, the data store can be located external to the computer such as, for example, an external hard drive connected to the I/O interfaces 304 (e.g., SCSI or USB connection). Finally in a third embodiment, the data store may be connected to the computer through a network, such as, for example, a network attached file server.

The memory 314 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 314 may incorporate electronic, magnetic, optical, and/or other types of storage media. Note that the memory 314 can have a distributed architecture, where various components are situated remotely from one another, but can be accessed by the processor 302.

The software in memory 314 can include one or more software programs, each of which includes an ordered listing of executable instructions for implementing logical functions. In the example of FIG. 3, the software in the memory system 314 includes the interactive process for an audio and video sales presentation, and a suitable operating system (O/S) 310. The operating system 310 essentially controls the execution of other computer programs, such as the process for the audio and video sales presentation, input-output control, file and data management, memory management, and communication control and related services. The operating system 310 can be any of Windows NT, Windows 2000, Windows XP, Windows Vista (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), or other like operating system with similar functionality.

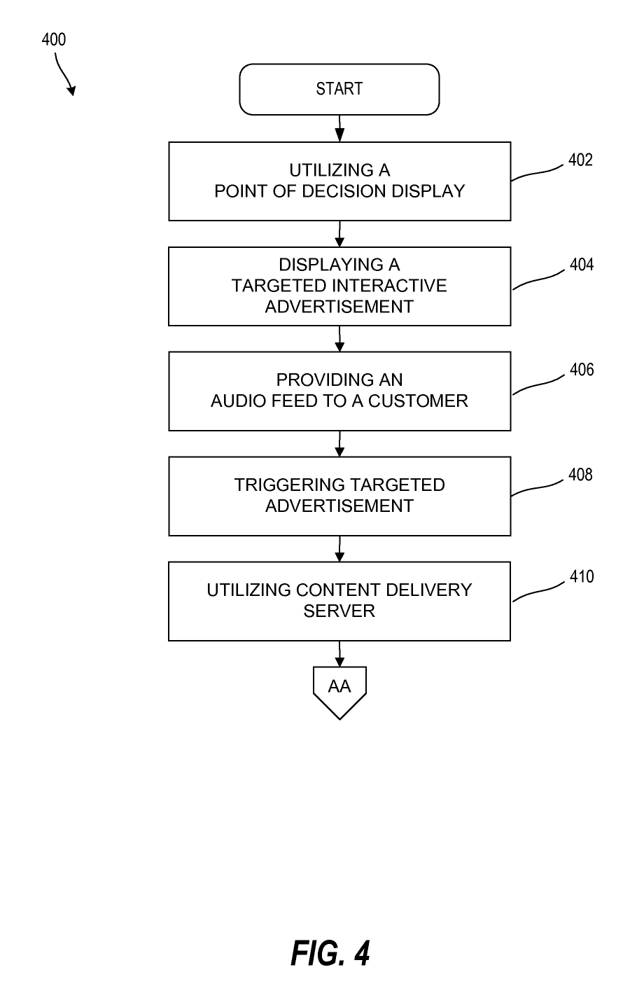

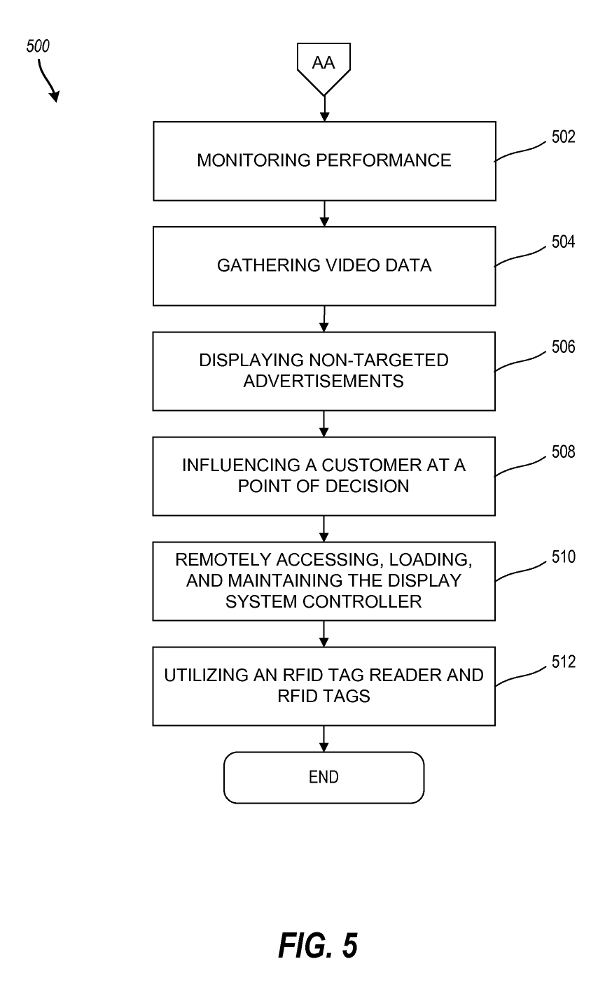

In an exemplary embodiment of the technology described herein, the computer is configured to perform flowcharts 400 and 500 depicted in FIGS. 4 and 5, respectively. The process for the point of decision display utilizing the computer, or more than one computer, is configured specifically to perform these tasks. However, it should be noted that all computer components described are not necessary for realizing the technology described herein.

Referring now to FIG. 4, a flowchart diagram 400 is shown. Diagram 400 includes method steps for implementing and utilizing a point of decision system 100.

In step 402, a point of decision display system 100, as described above, is utilized in a retail environment, or the like, to deliver a targeted interactive advertisement to a customer when the customer is in the process of making a decision about the purchase, or the like.

In step 404, a targeted interactive advertisement is displayed through a video display device operably coupled to a display system controller to a consumer when the consumer is in a process of making a decision.

In step 406, an audio feed is provided of the targeted interactive advertisement to the consumer, utilizing an audio output device operably coupled to the display system controller.

In step 408, the targeted interactive advertisement is triggered utilizing a presence sensor operably coupled to a sensor processing unit. The sensor processing unit is operably coupled to the display system controller and configured to trigger the display system controller to display the interactive advertisement to the consumer.

In step 410, the targeted interactive advertisement is provided to the customer. The targeted interactive advertisement includes content derived from a content delivery server operably coupled to the display system controller and configured to provide content through the display system controller and video display device to the consumer.

It will be clear to those skilled in the art, after reading this disclosure, which tasks depicted in FIG. 4 can be performed simultaneously or in a different order than that depicted.

Referring now to FIG. 5, a flowchart diagram 500 is shown. Diagram 500 includes additional method steps for implementing and utilizing a point of decision system 100.

In step 502, performance of the point of decision display system, and the effectiveness of its advertising, for example, is monitored utilizing a performance monitoring system operably coupled to the display system controller and configured to monitor performance of the point of decision display system and to gather a plurality of statistical data.

In step 504, video data is gathered utilizing a video sensor operably coupled to the display system controller and configured to gather a plurality of video data about the consumer in a process of making a decision.

In step 506, a plurality of general audience advertisements are displayed until a trigger event is sensed by the presence sensor and the targeted interactive advertisement is displayed to the consumer.

In step 508, video the customer is influenced at a point of decision with the targeted interactive advertisement.

In step 510, the display system controller is remotely accessed, loaded, and/or maintained from a remote content delivery server. The remote content delivery server is operably coupled to the display system controller over a communications network and configured to provide content to the display system controller over the communications network.

In step 512, a radio-frequency identification (RFID) system is utilized in the point of decision display system. The radio-frequency identification (RFID) system is operably coupled to the display system controller and includes an RFID tag reader and a plurality of RFID tags on a plurality of products accessible by the consumer.

It will be clear to those skilled in the art, after reading this disclosure, which tasks depicted in FIG. 5 can be performed simultaneously or in a different order than that depicted.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A point of decision display system, comprising:
a display system controller;
a video display device, operably coupled to the display system controller and configured to display an interactive advertisement to a consumer when the consumer is in a process of making a decision;
an audio output device, operably coupled to the display system controller and configured to provide audio for the interactive advertisement to the consumer;
a sensor processing unit, operably coupled to the display system controller and configured to trigger the display system controller to display the interactive advertisement to the consumer;
a presence sensor, operably coupled to the sensor processing unit and configured to sense the consumer in the process of making the decision; and
a content delivery server, operably coupled to the display system controller and configured to provide content through the display system controller and video display device to the consumer.

2. The point of decision display system of claim 1, further comprising:
a performance monitoring system, operably coupled to the display system controller and configured to monitor performance of the point of decision display system and to gather a plurality of statistical data.

3. The point of decision display system of claim 1, further comprising:
a video sensor, operably coupled to the display system controller and configured to gather a plurality of video data about the consumer in a process of making a decision.

4. The point of decision display system of claim 1, further comprising:
a radio-frequency identification (RFID) system, operably coupled to the display system controller and having an RFID tag reader, wherein a plurality of RFID tags are utilized on a plurality of products accessible by the consumer.

5. The point of decision display system of claim 1, wherein the presence sensor is a contact sensor.

6. The point of decision display system of claim 1, wherein the presence sensor is a motion sensor.

7. The point of decision display system of claim 1, wherein the presence sensor is an infrared sensor.

8. The point of decision display system of claim 1, wherein the presence sensor is a wireless sensor operably and wirelessly connected to the sensor processing unit.

9. The point of decision display system of claim 1, wherein the content delivery server is a remote content delivery server operably coupled to the display system controller over a communications network and configured to provide content to the display system controller over the communications network.

10. The point of decision display system of claim 1, wherein the display system controller further comprises: a processor, a video controller, and a sound controller.

11. The point of decision display system of claim 1, wherein the display system controller is further configured to display a plurality of general audience advertisements until a trigger event is sensed by the presence sensor and a targeted interactive advertisement is displayed.

12. A method for point of decision advertising, comprising:
utilizing a point of decision display system;
displaying a targeted interactive advertisement, through a video display device operably coupled to a display system controller, to a consumer when the consumer is in a process of making a decision;
providing an audio feed of the targeted interactive advertisement to the consumer, utilizing an audio output device operably coupled to the display system controller; and
triggering the targeted interactive advertisement to be displayed to the consumer, utilizing a presence sensor operably coupled to a sensor processing unit, the sensor processing unit operably coupled to the display system controller and configured to trigger the display system controller to display the interactive advertisement to the consumer.

13. The method for point of decision advertising of claim 12, further comprising:
providing the targeted interactive advertisement to the consumer, wherein the targeted interactive advertisement comprises a content derived from a content delivery server operably coupled to the display system controller and configured to provide content through the display system controller and video display device to the consumer.

14. The method for point of decision advertising of claim 12, further comprising:
monitoring performance of the advertising utilizing a performance monitoring system operably coupled to the display system controller and configured to monitor performance of the point of decision display system and to gather a plurality of statistical data.

15. The method for point of decision advertising of claim 12, further comprising:
gathering a plurality of video data utilizing a video sensor operably coupled to the display system controller and configured to gather a plurality of video data about the consumer in a process of making a decision.

16. The method for point of decision advertising of claim 12, further comprising:
displaying a plurality of general audience advertisements until a trigger event is sensed by the presence sensor and the targeted interactive advertisement is displayed to the consumer.

17. The method for point of decision advertising of claim 12, further comprising:
influencing the customer at a point of decision with the targeted interactive advertisement.

18. The method for point of decision advertising of claim 13, further comprising:
remotely accessing, loading, and maintaining, from the content delivery server, the display system controller, wherein the content delivery server is a remote content delivery server operably coupled to the display system controller over a communications network and configured to provide content to the display system controller over the communications network.

19. The method for point of decision advertising of claim 12, further comprising:
utilizing a radio-frequency identification (RFID) system operably coupled to the display system controller and having an RFID tag reader; and
utilizing a plurality of RFID tags on a plurality of products accessible by the consumer.

20. The method for point of decision advertising of claim 12, wherein the presence sensor is one of a contact sensor, motion sensor, infrared sensor, and wireless sensor.
